(19) United States
(12) Patent Application Publication
(10) Pub. No.: US 2013/0074190 A1
(43) Pub. Date: Mar. 21, 2013

(54) APPARATUS AND METHOD FOR PROVIDING SECURITY FUNCTIONS IN COMPUTING SYSTEM

(71) Applicants: Hong IL JU, Daejeon (KR); YoungHo KIM, Seoul (KR); Jeong Nyeo KIM, Seoul (KR); Yong-Sung JEON, Daejeon (KR); Yun-Kyung LEE, Daejeon (KR)

(72) Inventors: Hong IL JU, Daejeon (KR); YoungHo KIM, Seoul (KR); Jeong Nyeo KIM, Seoul (KR); Yong-Sung JEON, Daejeon (KR); Yun-Kyung LEE, Daejeon (KR)

(73) Assignee: Electronics and Telecommunications Research Institute, Daejeon (KR)

(21) Appl. No.: 13/593,846

(22) Filed: Aug. 24, 2012

(30) Foreign Application Priority Data
Sep. 16, 2011 (KR) 10-2011-0093701

(51) Int. Cl. G06F 21/00

(52) U.S. Cl. 726/26

(57) ABSTRACT

An apparatus for providing security functions in a computing system includes: at least one normal service domain executing service; a secure service domain performing integrity verification on a service execution environment of at least one normal service domain, and performing the security service function for the service in accordance with the result of the integrity verification; and a virtual machine monitor separating service execution environments of at least one normal service domain and the secure service domain, respectively, based on the same hardware device. According to the present invention, it is possible to enhance the security for execution environments of the computing system and the data stored in the system, by allowing the corresponding services, which need security service functions in the normal service domain, to be executed necessarily only when integrity verification of the execution environment succeeds by linking the secure service domain.

### CROSS-REFERENCES TO RELATED APPLICATIONS

The present application claims priority under 35 U.S.C 119(a) to Korean Application No. 10-2011-0093701, filed on Sep. 16, 2011, in the Korean Intellectual Property Office, which is incorporated herein by reference in its entirety set forth in full.

### BACKGROUND

Exemplary embodiments of the present invention relate to an apparatus and a method for providing security functions in a computing system, and more particularly, to an apparatus and a method for providing security functions in a computing system by separating an execution environment for a secure service domain and normal service domains, based on a virtualization technology.

When an attacker acquires the authority of a manager in a computing system and takes control of the system by hacking or attacking with a virus, the attacker can extract a variety of important information or cause malfunction of the system regardless of the intention of the user.

Desktop PCs and servers of the related art are provided with various security programs or security equipment, and somewhat take precautions against these attacks. But mobile terminals, such as tablet PCs or smart phones which are increasingly used in recent year, are not sufficiently provided with precautions against the attacks and are exposed to attacks from the outside.

In particular, since smart phones are always turned on and can be connected to a network any time, anywhere, attackers can attack any time if they intend to do so, and thus the smart phones are very vulnerable in security.

Therefore, a technology of providing security functions by separating the execution environment for an individual and business, based on a virtualization technology using a hypervisor or a VMM (Virtual Machine Monitor), or by installing security programs has been used in order to protect terminals from those attacks.

However, since the execution environment for business is only separated and the security programs are applied, only services executing on the separated execution environment are different. And even the execution environment for business may be attacked in the same way, similar to the execution environment for the individual.

Further, since security programs detecting malicious codes and removing viruses are performed on the operation systems of the separated execution environments, when the operation systems of the separated execution environment or the security programs themselves are attacked, sufficient security functions cannot be provided.

The above-mentioned technical configuration is a background art for helping understanding of the present invention and does not mean related arts well known in a technical field to which the present invention pertains.

### SUMMARY

An embodiment of the present invention is directed to an apparatus and a method for providing security functions in a computing system capable of separating an execution environment for a secure service domain and normal service domains by using a virtualization technology, and of ensuring a secure execution environment for the normal service domain by using the secure service domain.

An embodiment of the present invention relates to an apparatus for providing security functions in a computing system, including: at least one normal service domain executing service; a secure service domain performing integrity verification on a service execution environment of at least one normal service domain that requests performing of a security service function, and performing the security service function for the service in accordance with the result of the integrity verification; and a virtual machine monitor separating service execution environments of at least one normal service domain and the secure service domain, respectively, based on the same hardware device.

The secure service domain may perform the security service function when the integrity verification on a service execution environment of the normal service domain that requests performing of a security service function succeeds, and may transmit the result of performing the security service function to the normal service domain.

When the security service function of the secure service domain is required, the normal service domain may request the secure service domain to perform the security service function and may execute the service by using the result of performing the security service function.

The secure service domain may block the security service function, when the integrity verification of the execution environment of the normal service domain that requests performing of the security service function fails.

When the integrity verification of the execution environment of the normal service domain that requests performing of the security service function fails, the secure service domain may block all of security service functions that may be requested by the corresponding normal service domain.

When the integrity verification of the execution environment of the normal service domain that requests performing of the security service function fails, the secure service domain may transmit a warning message and a message containing security measures to the corresponding normal service domain.

The secure service domain may include a security monitoring program that performs integrity verification on the service execution environment of the normal service domain.

The security monitoring program may perform the integrity verification on the execution environment of the normal service domain by monitoring at least one or more of process information, file system information, and memory information of the normal service domain.

The secure service domain may perform the security service function, based on a security operating system.

Another embodiment of the present invention provides a method of providing security functions in a computing system, including: receiving, by a secure service domain, a request of performing a security service function for executing a service from a normal service domain; and performing, by the secure service domain, integrity verification on a service execution environment of the normal service domain, when the security service function is requested.

The method may further include: performing, by the secure service domain, the requested security service function, when the integrity verification succeeds, and transmitting the result of performing the security service function to the normal service domain.

The method may further include executing, by the normal service domain, the service by using the result of performing the security service function.

The method may further include blocking, by the secure service domain, the security service function requested by the normal service domain, when the integrity verification fails.

The blocking of a security service function may block all of security service functions that may be requested by the normal service domain to the secure service domain.

The method may further include transmitting, by the secure service domain, a warning message and a message containing security measures to the normal service domain, when the integrity verification fails.

### BRIEF DESCRIPTION OF THE DRAWINGS

The above and other aspects, features and other advantages will be more clearly understood from the following detailed description taken in conjunction with the accompanying drawings, in which:

FIG. 1 illustrates a block diagram of an apparatus for providing security functions in a computing system in accordance with an embodiment of the present invention;

FIG. 2 illustrates a block diagram of a security monitoring program of the apparatus for providing security functions in a computing system in accordance with the embodiment of the present invention;

FIG. 3 is a flowchart illustrating a process in which a secure service domain is requested to perform a security service function from a normal service domain and performs the function, in a method for providing security functions in a computing system in accordance with an embodiment of the present invention; and

FIG. 4 is a flowchart illustrating a process in which the normal service domain executes a service by linking the secure service domain, in the method for providing security functions in a computing system in accordance with the embodiment of the present invention.

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention.

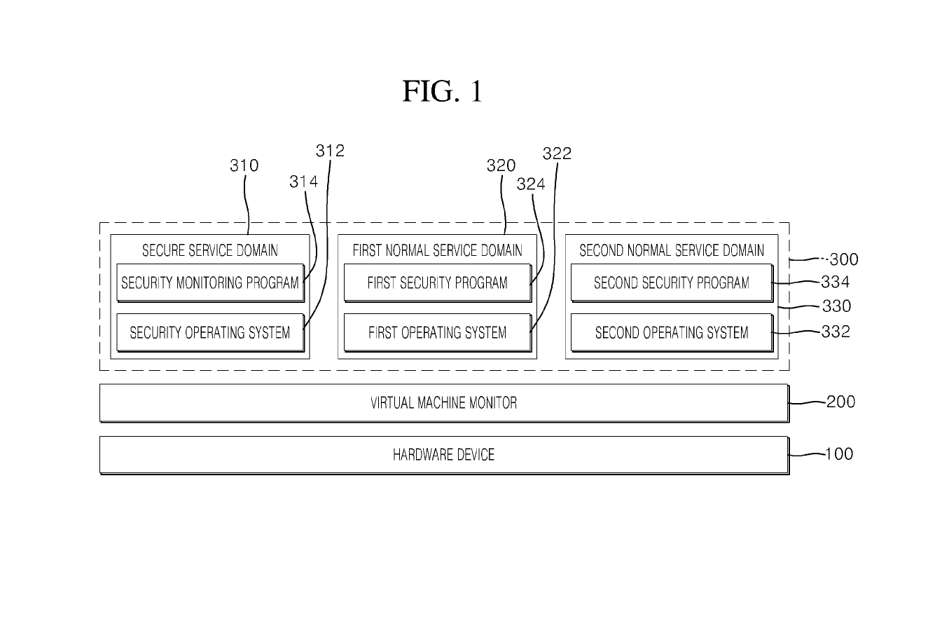

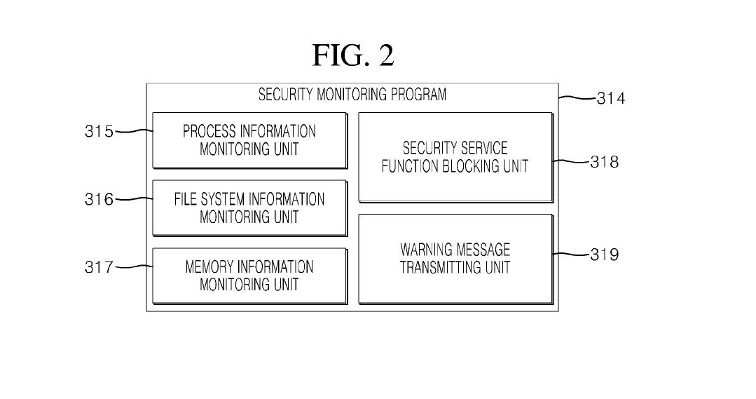

FIG. 1 illustrates a block diagram of an apparatus for providing security functions in a computing system in accordance with an embodiment of the present invention and FIG. 2 illustrates a block diagram of a security monitoring program of the apparatus for providing security functions in a computing system in accordance with the embodiment of the present invention.

As illustrated in FIG. 1, an apparatus for providing security functions in a computing system in accordance with an embodiment of the present invention includes a hardware device 100, a virtual machine monitor 200, and a domain unit 300.

The hardware device 100 may include various devices that provide physical resources, such as a central processing unit (not shown), a memory (not shown), and an input/output device (not shown), as devices providing physical resources.

The virtual machine monitor 200 is a virtual platform that makes it possible to drive a plurality of operating systems in one computing system, based on the hardware device 100, and virtualizes the plurality of operating system by loading the operating systems on separated domains, respectively, in order that the domains are able to construct independent execution environments.

That is, it is possible to construct a plurality of different execution environments using the same physical resources in one computing system through the virtual machine monitor 200.

The domain unit 300 may include a secure service domain 310 and at least one or more normal service domains.

The normal service domain means a domain where normal services are executed and may be configured by one or more domains that operates, based on different operating systems.

That is, the normal service domain may include a first normal service domain 320 and a second normal service domain 330 that have first and second operating systems 322 and 332 and first and second security programs 324 and 334, respectively.

Herein, the first and second operating systems 322 and 332 provided for the first and second normal service domains 320 and 330 are operating systems used for executing normal services and include various operating systems that have been known and widely used.

When executing services that need security, the normal service domain executes the services by linking the secure service domain 310. The detailed process of executing a service that needs security by linking the secure service domain 310 in the normal service domain will be described below.

Meanwhile, the secure service domain 310 means a domain where a security service function is performed, and has a security operating system 312 and a security monitoring program 314. The secure service domain 310 monitors the service execution environment of the normal service domain through a security monitoring program 314, based on the security operating system 312.

Herein, the security operating system 312 is an operating system that performs a security service function in the secure service domain 310. The secure service domain 310 is capable of performing only a security service function by providing a password algorithm and security libraries, based on the security operating system 312, unlike the normal service domain.

Further, the secure service domain 310 can perform a service of the secure service domain 310 itself, if necessary, and may include key information including key management, important data information, and the like.

The secure service domain 310 cannot execute services that are executed in the normal service domain and common users are generally not able to recognize whether there is the secure service domain 310.

The security monitoring program 314 monitors the entire execution environment of a normal service domain including the security program and the operating system of a normal service domain that request performing of a security service function, and performs integrity verification.

As shown in FIG. 2, the security monitoring program 314 may include a process information monitoring unit 315, a file system information monitoring unit 316, a memory information monitoring unit 317, a security service function blocking unit 318, and a warning message transmitting unit 319.

The process information monitoring unit 315, the file system information monitoring unit 316, the memory information monitoring unit 317 perform integrity verification by monitoring the process information, file system information, and memory information of a normal service domain, respectively, which requests performing of a security service function.

When the integrity verification performed by the process information monitoring unit 315, the file system information monitoring unit 316, and the memory information monitoring unit 317 fails, the security service function blocking unit 318 can block the security service function requested by the corresponding normal service domain.

In detail, when the integrity verification fails, the security service function blocking unit 318 can block all of commands and interfaces for performing the security service function requested by the corresponding normal service domain.

The security service function blocking unit 318 can blocks all the security service functions requested by the corresponding normal service domain, in addition to the present requested security service function.

When the integrity verification performed by the process information monitoring unit 315, the file system information monitoring unit 315, and the memory information monitoring unit 317 fails, the warning message transmitting unit 319 transmits a message that the execution environment of the corresponding normal service domain is not safe and a message containing security measures to the corresponding normal service domain.

Meanwhile, when the integrity verification succeeds, the secure service domain 310 can perform the security service function requested by the corresponding normal service and transmit the result of performing the security service function to the corresponding normal service domain.

Accordingly, the corresponding normal service domain can execute the corresponding service, using the received result of performing the security service.

As a result, the corresponding service can be executed at the corresponding normal service domain, only when the integrity verification for the execution environment of the corresponding services succeeds.

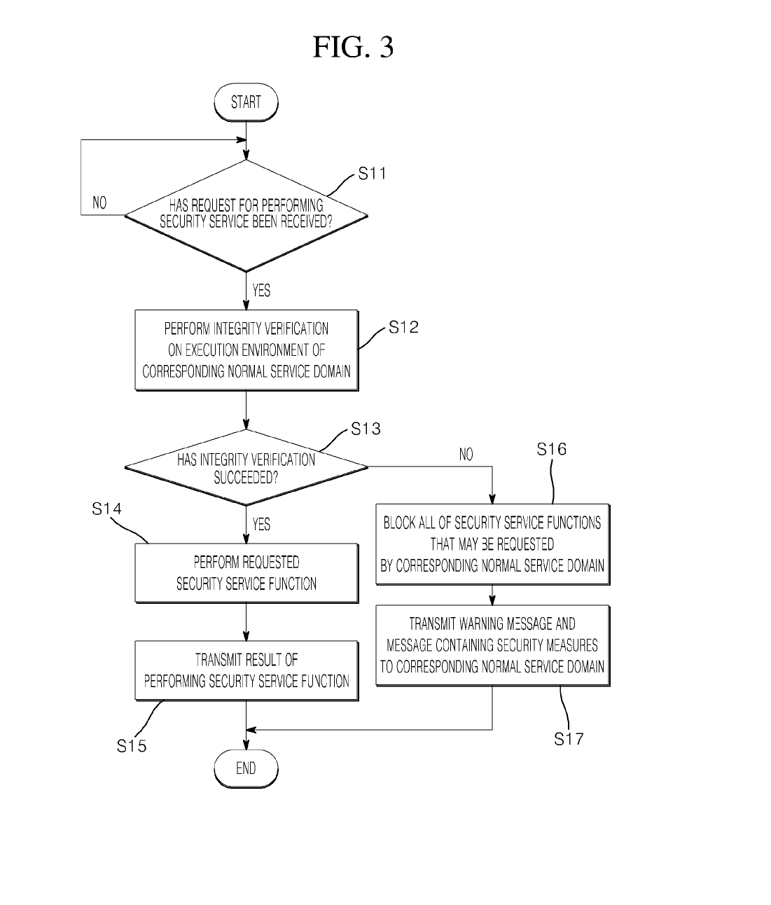

FIG. 3 is a flowchart illustrating a process in which a secure service domain is requested to perform a security service function from a normal service domain and performs the function, in a method for providing security functions in a computing system in accordance with an embodiment of the present invention. The detailed operation of the present invention will be described with reference to FIG. 3.

As shown in FIG. 3, the secure service domain 310 checks whether a request for performing a security service function is received from a normal service domain (S11).

If a request for performing a security service function is received, the secure service domain 310 performs integrity verification on the execution environment itself that include the operating system of the normal service domain that requests performing of the security service function through the security monitoring program 314 (S12).

In detail, the secure service domain 310 can verify integrity of the execution environment by monitoring the process information, the file system information, and the memory information of the corresponding normal service domain, through the process information monitoring unit 315, the file system information monitoring unit 316, and the memory information monitoring unit 317 of the security monitoring program 314.

Thereafter, the secure service domain 310 determines whether the integrity verification succeeds (S13), and when the integrity verification succeeds, the secure service domain 310 performs the requested security service function (S14) and transmits the result of performing the security service function to the normal service domain that has requested the corresponding service (S15).

Accordingly, the normal service domain executes the corresponding service, using the received result of performing the security service function.

On the contrary, when the integrity verification fails, the secure service domain 310 can blocks all security service functions that can be requested by the corresponding normal service domain, through the security service function blocking unit 318 of the security monitoring program 314 (S16).

That is, the normal service domain that has failed with the integrity verification cannot receive any more the result of performing security service function, even if it requests a security service function to the secure service domain 310.

As described above, when the integrity verification of a service execution environment fails, not only the present requested security service function, but the security service functions for all of services relating to the following corresponding domains are blocked, and thus it is possible to prevent any attacks and hacking through normal service domains with a problem.

Thereafter, the secure service domain 310 can warn the corresponding normal service domain that the corresponding service execution environment is not safe, by transmitting a warning message through the warning message transmitting unit 319 of the security monitoring program 314 (S17).

As described above, it is possible to enhance the security for execution environments of the computing system and the data stored in the system, by allowing the services, which need security service functions in the normal service domain, to be executed necessarily only when integrity verification of the execution environment succeeds by linking the secure service domain.

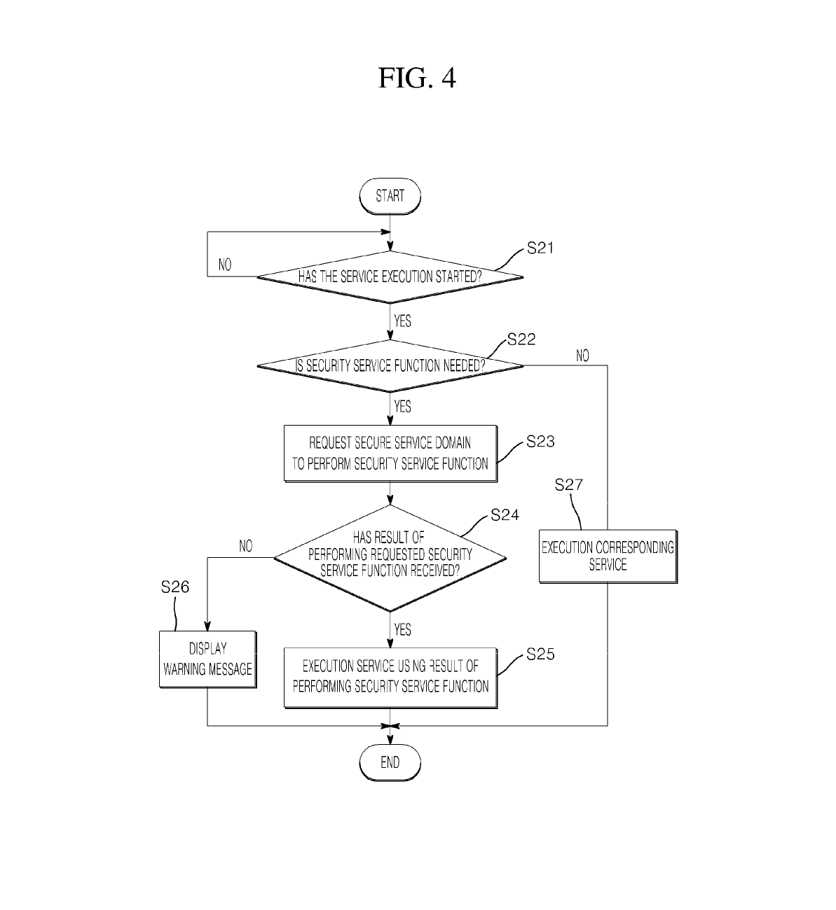

FIG. 4 is a flowchart illustrating a process in which the normal service domain executes a service by linking the secure service domain, in the method for providing security functions in a computing system in accordance with the embodiment of the present invention. The detailed operation is described with reference to FIG. 4.

First, the normal service domain checks whether the service execution started (S21), and then checks whether a security service function is necessary for executing the corresponding service (S22) when the service performing started.

If the service needs a security service function, the normal service domain requests the secure service domain 310 to perform the security service function (S23).

Thereafter, the normal service domain checks whether the result of performing a security service function is received from the secure service domain 310 (S24), and then executes the service by using the corresponding performing result when the result of performing the requested security service function is received (S25).

On the contrary, when the result of performing the security service function is not received from the secure service domain 310 or a warning message is received, the normal service domain warns the user that the present service execution environment is not safe by displaying a warning message and informs the user of the corresponding security measures (S26).

It is possible to allow the user who executes a service to recognize in advance any attacks and the danger of hacking and take corresponding security actions, by warning the user that the service execution environment is not safe and inform the user of the corresponding security measures, as described above.

Meanwhile, when it is not necessary to perform a security service function in order to execute the corresponding service in S22, the normal service domain executes the corresponding service in the normal service domain without linking the secure service domain 310 (S27).

As described above, the present invention has the advantage of being able to construct a secure service environment independently from a virtual machine monitor, by enhancing security for a normal service domain execution environment through the secure service domain 310.

Meanwhile, although it is exemplified in the present embodiment that the normal service domain is configured by two normal service domains 320 and 330, the number of normal service domains may be selected in various ways. That is, the normal service domain may be configured by one normal service domain or three or more normal service domains.

The embodiments can enhance the security for the service execution environment and the data stored in the system, by allowing the services, which need security service functions in the normal service domain, to be executed necessarily only when integrity verification of the execution environment succeeds by linking the secure service domain.

Further, the embodiments can block not only the present requested security service function, but the security service functions for all of services relating to the following corresponding domains, when the integrity verification of service execution environment fails in a normal service domain, and thus it is possible to prevent any attacks and hacking through normal service domains with a problem.

In particular, the embodiments have the advantage that it is possible to construct a security service environment independently from a hypervisor or a virtual machine monitor, and to allow a user to recognize in advance any attacks and the danger of hacking and take relating security measures, by informing the user who uses the service that the service execution environment is not safety.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. An apparatus for providing security functions in a computing system, comprising:
at least one normal service domain executing service;
a secure service domain performing integrity verification on a service execution environment of at least one normal service domain that requests performing of a security service function, and performing the security service function for the service in accordance with the result of the integrity verification;
and a virtual machine monitor separating service execution environments of at least one normal service domain and the secure service domain, based on the same hardware device.

2. The apparatus of claim 1, wherein the secure service domain performs the security service function when the integrity verification succeeds, and transmits the result of performing the security service function to the normal service domain.

3. The apparatus of claim 2, wherein the normal service domain executes the service by using the result of performing the security service function.

4. The apparatus of claim 1, wherein the secure service domain blocks a security service function requested by the normal service domain, when the integrity verification fails.

5. The apparatus of claim 4, wherein the secure service domain blocks all of security service functions that may be requested by the normal service domain.

6. The apparatus of claim 1, wherein the secure service domain transmits a warning message and a message containing security measures to the normal service domain, when the integrity verification fails.

7. The apparatus of claim 1, wherein the secure service domain includes a security monitoring program performing integrity verification on the service execution environment of the normal service domain.

8. The apparatus of claim 7, wherein the security monitoring program performs the integrity verification by monitoring at least one or more of process information, file system information, and memory information of the normal service domain.

9. The apparatus of claim 1, wherein the secure service domain performs the security service function, based on a security operating system.

10. A method of providing security functions in a computing system, comprising:
receiving, by a secure service domain, a request of performing a security service function for executing a service from a normal service domain;
and performing, by the secure service domain, integrity verification on a service execution environment of the normal service domain, when the security service function is requested.

11. The method of claim 10, further comprising:
performing, by the secure service domain, the requested security service function, when the integrity verification succeeds;
and transmitting the result of performing the security service function to the normal service domain.

12. The method of claim 11, further comprising: executing, by the normal service domain, the service by using the result of performing the security service function.

13. The method of claim 10, further comprising: blocking, by the secure service domain, the security service function requested by the normal service domain, when the integrity verification fails.

14. The method of claim 13, wherein the blocking of a security service function blocks all of security service functions that may be requested by the normal service domain.

15. The method of claim 10, further comprising:
transmitting, by the secure service domain, a warning message and a message containing security measures to the normal service domain, when the integrity verification fails.
